(19) United States
(12) Patent Application Publication
(10) Pub. No.: US 2016/0231124 A1
(43) Pub. Date: Aug. 11, 2016

(54) HORIZON-BASED DRIVER ASSISTANCE SYSTEMS AND METHODS

(71) Applicant: GM GLOBAL TECHNOLOGY OPERATIONS LLC, Detroit, MI (US)

(72) Inventors: JAMES N. NICKOLAOU, CLARKSTON, MI (US); SARMAD Y. HERMIZ, TROY, MI (US)

(73) Assignee: GM GLOBAL TECHNOLOGY OPERATIONS LLC, Detroit, MI (US)

(21) Appl. No.: 14/992,335

(22) Filed: Jan. 11, 2016

Related U.S. Application Data
(60) Provisional application No. 62/103,819, filed on Jan. 15, 2015.

(51) Int. Cl. G01C 21/34; B60R 16/023

(52) U.S. Cl. CPC G01C 21/34; B60R 16/023

(57) ABSTRACT

A driver assistance method includes determining, with a horizon provider module, a first path comprising a first road segment and a second road segment based on a position of a vehicle and a predetermined horizon distance. A second path comprising the first road segment and a third road segment is determined based on the position of the vehicle and the predetermined horizon distance. Path data characterizing the first path, the second path, a position of the vehicle relative to the first path, and a position of the vehicle relative to the second path is then transmitted to a reconstructor module.

### CROSS-REFERENCE TO RELATED APPLICATIONS

This application claims priority to U.S. Provisional Patent Application No. 62/103,819, filed Jan. 15, 2015, the contents of which are hereby incorporated by reference.

### TECHNICAL FIELD

The technical field generally relates to automotive vehicles, and more particularly relates to advanced driver assistance systems (ADAS) used in connection with automotive vehicles.

### BACKGROUND

Modern automotive vehicles increasingly incorporate advanced driver assistance systems (ADAS) designed to automate and/or enhance the driving process and to increase the overall safety of the vehicle during operation. One such system, the “horizon-based” driver assistance system, utilizes map data and external sensor data to predict the path that the vehicle is likely to take along as it travels along the roadway.

While such driver assistance systems are advantageous in many respects, there remain a number of unresolved issues associated with their operation. For example, horizon-based driver assistance systems typically depend on communication (e.g., via a car area network (CAN) bus) of road and path data from a map module to the various subsystems and devices requiring that data (e.g., electronic control units (ECUs) and the like). More particularly, the map module generally includes a “horizon provider” that provides data-of-interest to a reconstructor module in the ECU, which has the responsibility of constructing the desired path. Unfortunately, since the map module generally only provides a single path to the reconstructor module along with information regarding the position of the vehicle on that path, when the driver of the vehicle takes a different path (e.g., at a fork in the road), the reconstructor module must quickly recover and stay in synch with the horizon provider, which can take an undesirable length of time.

Accordingly, it is desirable to provide improved horizon-based driver assistance systems and methods. Additional desirable features and characteristics of the present invention will become apparent from the subsequent detailed description and the appended claims, taken in conjunction with the accompanying drawings and the foregoing technical field and background.

### DESCRIPTION OF THE DRAWINGS

The exemplary embodiments will hereinafter be described in conjunction with the following drawing figures, wherein like numerals denote like elements, and wherein:

FIG. 1 is a conceptual block diagram of a driver assistance system in accordance with one embodiment.

FIGS. 2-6 present example paths and associated road segments useful in describing an exemplary embodiment.

FIG. 7 depicts path data in accordance with the example of FIGS. 2-6.

FIGS. 8 and 9 are flowcharts depicting, collectively, an exemplary driver assistance method in accordance with one embodiment.

### DETAILED DESCRIPTION

The subject matter described herein generally relates to a horizon-based advanced driver assistance system (ADAS) in which the horizon provider module provides two or more candidate paths to the reconstructor module along with information regarding the position of the vehicle relative to each of those paths. In this way, more of the computational burden of finding and reconstructing the path is performed by the map module instead than the reconstructor module. In this way, the system can quickly recover from unexpected changes in the vehicle's path. In that regard, the following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

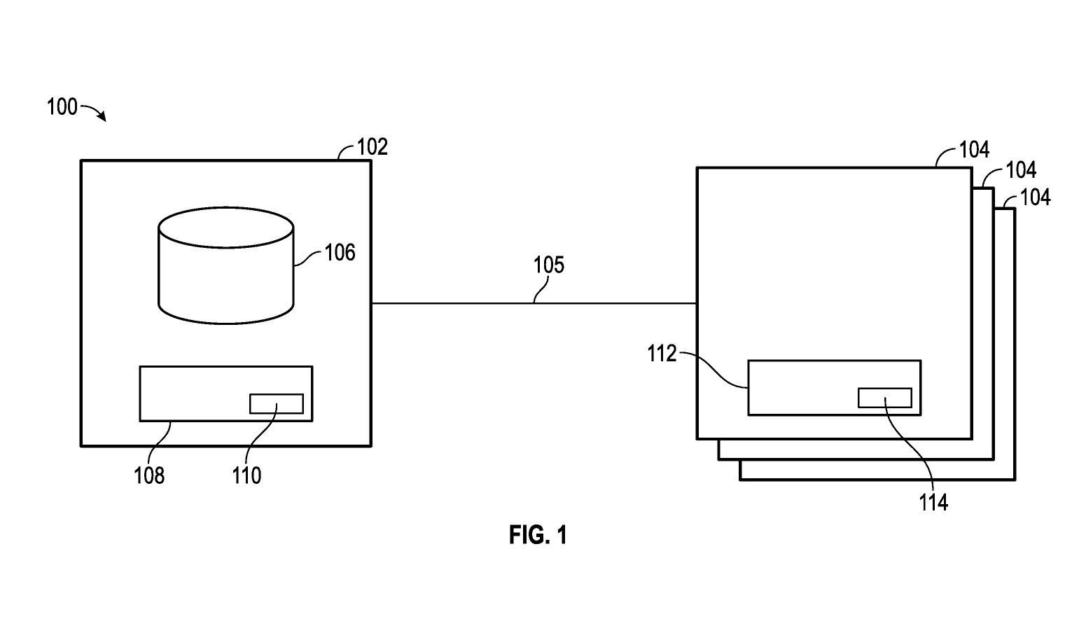

Referring now to FIG. 1, a conceptual block diagram of a driver assistance system 100 in accordance with an exemplary embodiment will now be described. As shown, system 100 generally includes a map module 102 configured to communicate with one or more devices 104 via any suitable network or bus 105 (e.g., a car area network (CAN)). A device 104 may correspond, for example, to an electronic control unit (ECU) or any other device configured to receive information from map module 102. Any number of additional components and subsystems may communicate with module 102 and/or device 104 over bus 105, including various sensors 121 and 122 (e.g., global-position system (GPS) sensors, inertial sensors, yaw-rate sensors, speed sensors, steering sensors, etc.)

Map module 102 includes a database 106 configured to store map data regarding road segments, map attributes, and any other data that might be associated with a geographical map. As used herein, the term “road segment” refers to any discrete portion of road that is bounded in some way—e.g., by an intersection, freeway entrance, exit, etc. Each road segment is generally identified by a segment ID (e.g., an integer or alphanumerical string). As will be appreciated, database 106 may store information regarding thousands or even millions of such segments. The term “path” refers to a sequence of road segments ordered based on the driving direction, and may be characterized by a “path record,” which in one embodiment is an integer (e.g. ranging from 8-63), with a value of zero indicating that no path is currently known.

Map module 102 also includes a horizon provider module (or simply “module”) 108 configured to store path information (described in further detail below). Similarly, device 104 includes a reconstructor module 112 also configured to store path information 114. In general, horizon provider module is configured to send path data 110 to reconstructor module 112 along with information regarding the position of the vehicle and path attributes (e.g., the curvature, speed limit, grade, number of lanes, etc. of the various road segments). Module 108 will generally only send data associated with segments within a predetermined distance (i.e., a predetermined horizon distance) of the vehicle (e.g., 1-2 km).

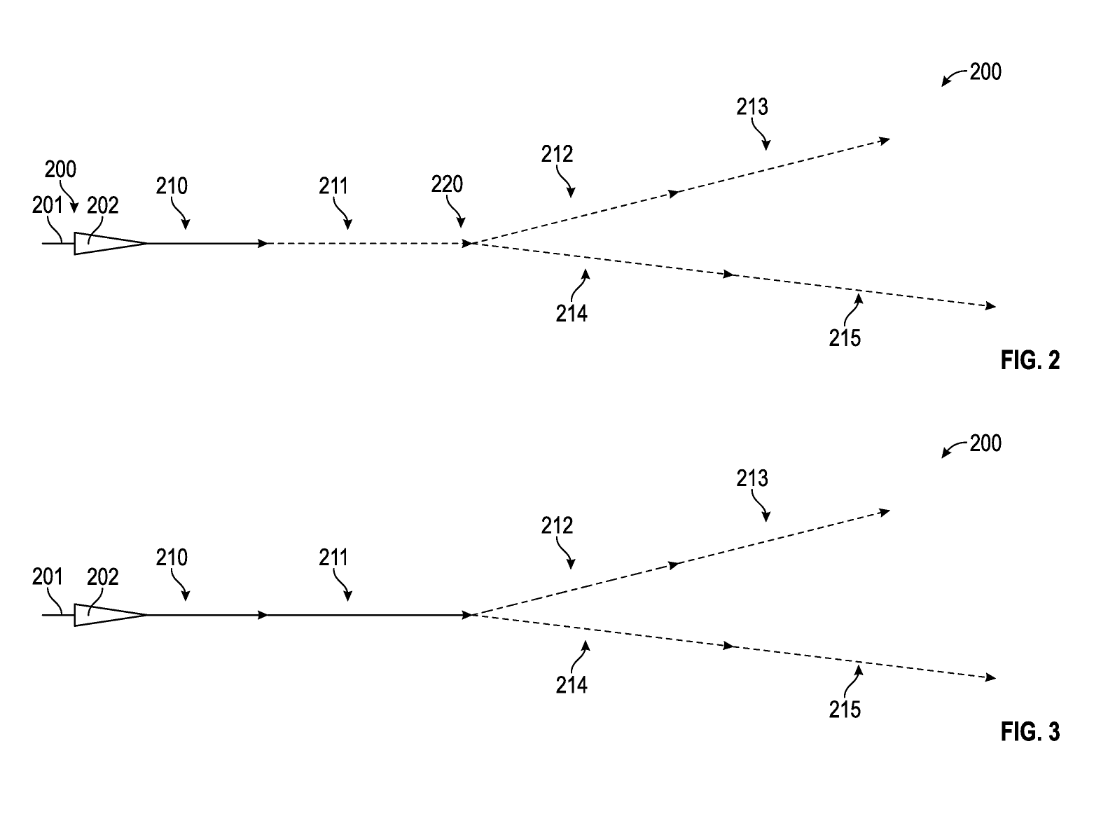

In accordance with various embodiments, horizon provider module 108 provides reconstructor with multiple possible paths (e.g., two or more), rather than a single path as provided by currently known system. In order to illustrate this feature, FIGS. 2-6 present example paths and associated road segments.

Referring first to FIG. 2, a roadway topology 200 for a given horizon includes a segment 210, which continues on to a segment 211, which then splits at a point 220 to two possible segments: 212 and 214. Segment 213 follows (or “extends from”) segment 212, and segment 215 follows segment 214. The vehicle (202) is, in this example, traveling along segment 210 at some known distance from a point 201 on that segment. It will be appreciated that, within roadway topology 200, there are two major paths available to vehicle 202: a path including the sequence of segments 210, 211, 212, and 213, and a second path including the sequence of segments 210, 211, 214, and 215. Segments 210, 211, 212, 213, 214, and 215 may also be referred to herein as segments A, B, C, D, E, and F, respectively.

In accordance with prior art driver assistance systems, the horizon provider module would only provide the reconstructor module with one path (i.e., one sequence of road segments). For example, the driver assistance system might, judging by vehicle 202 being in the left lane, assume that the driver is going to take the path described by segments 210, 211, and 212, and therefore only send that path information to the reconstructor module. This is illustrated in FIG. 3, wherein the long dashed lines indicate the assumed segment to be taken after the intersection.

Note that paths may be defined by only two segments, and can thus be “chained” together to define a larger path. In FIG. 3, for example, a path with path ID of “8” corresponds to segment 210 with an extension on segment 211, and a path with path ID of “9” corresponds to segment 211 with an extension on segment 212. Together, then, paths “8” and “9” define a larger path including segments 210, 211, 212, which would then be provided to reconstructor module 112 along with information regarding the position of vehicle 202 on segment 210 (e.g., relative to point 201).

In prior art systems, the reconstructor module might also receive fragmentary information regarding the existence of segments 214 and 215, but would not receive information regarding the position of vehicle 202 relative to those segments.

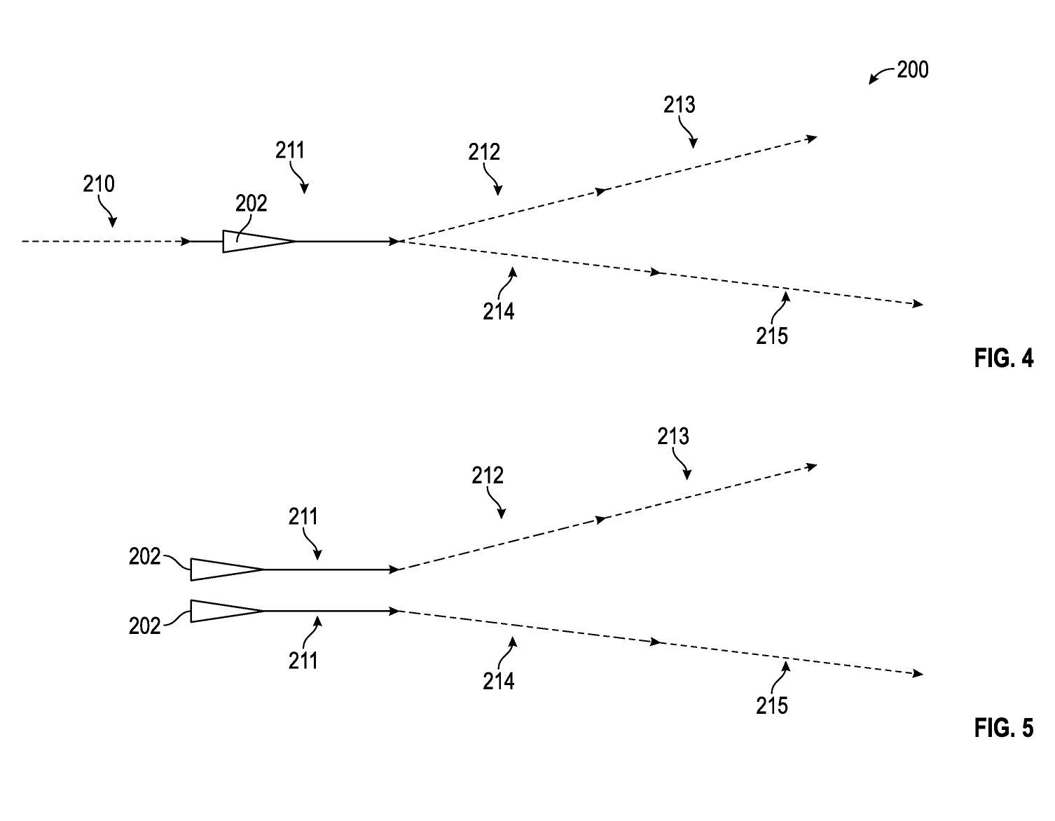

FIG. 4 depicts a subsequent time in which vehicle 202 has progressed to segment 211, in which two major paths now present themselves: one including segments 211, 212, and 213, and the other including segments 211, 214, 215. In accordance with the present invention, horizon provider module 108 provides both paths to reconstructor module 112 along with information regarding the position of vehicle 202 relative to both of those paths. This is illustrated in FIG. 5, which shows a path with path ID “9” including segments 211 and 212 (and an extension onto segment 213), and a path with path ID “10” including segments 211 and 214 (with an extension on to segment 215). Significantly, vehicle 202 is illustrated in both paths, indicating that the position of vehicle 202 relative to segment 211 (e.g., distance from point 203 in FIG. 4) is provided to reconstructor module 112 for both paths. Note that both paths are provided to reconstructor module during the same iteration (e.g., the same iteration of sensor measurements). That is, while prior art systems might send multiple paths at different times (and when the vehicle is in different positions), systems and methods in accordance with the present embodiments send two full paths at substantially the same time while the vehicle is substantially the same position.

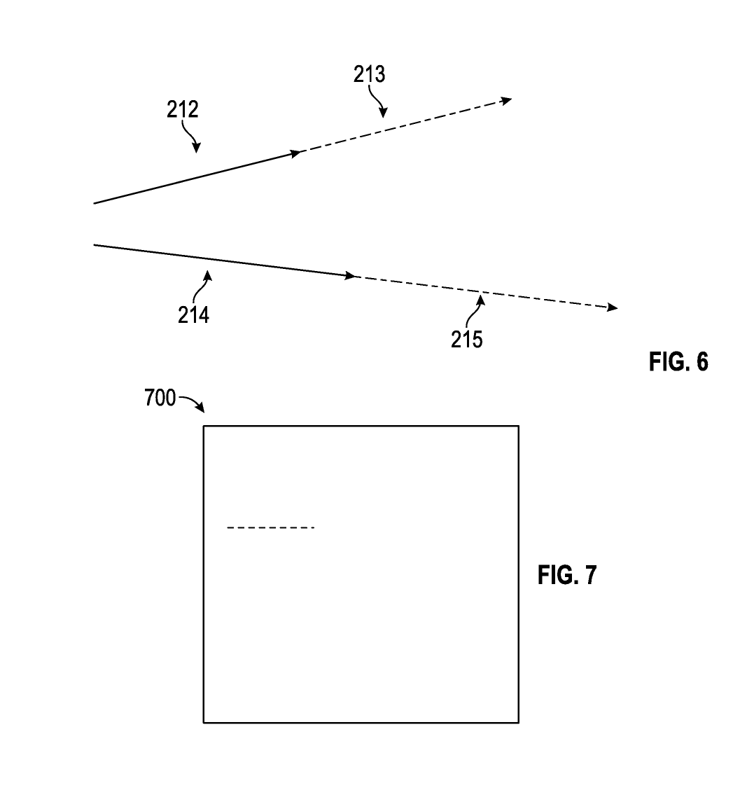

FIG. 6 further illustrates a path with path ID “11” including segments 212 and 213, and a path with path ID “8” including segments 214 and 215. Note that path ID “8”, which was previously used in connection with segment 210 of FIG. 2, can now be “re-used” as a designator for the path shown in FIG. 6, since segment 210 is no longer relevant, given the direction of vehicle 202 in this example.

FIG. 7 depicts path data 700 (or a “path table”) in accordance with the example depicted in FIGS. 5-6. Path data 700 may take a variety of forms and may be stored in any suitable data structure. In the illustrated embodiment, path data 700 includes: (1) an indicator that vehicle 202 is currently on segment 211 (“B”), the position of vehicle 202 on path ID “9”, the position of vehicle 202 on path ID “10”, and then a definition of the paths themselves, e.g., path ID 9=segment B->segment C, and path ID 10=segment B ->segment E. Also illustrated are the path definitions for path ID 11 and 8, as shown in FIG. 6. Path data 700 may thus correspond to data 114 of FIG. 1, as well as data 110 of module 108.

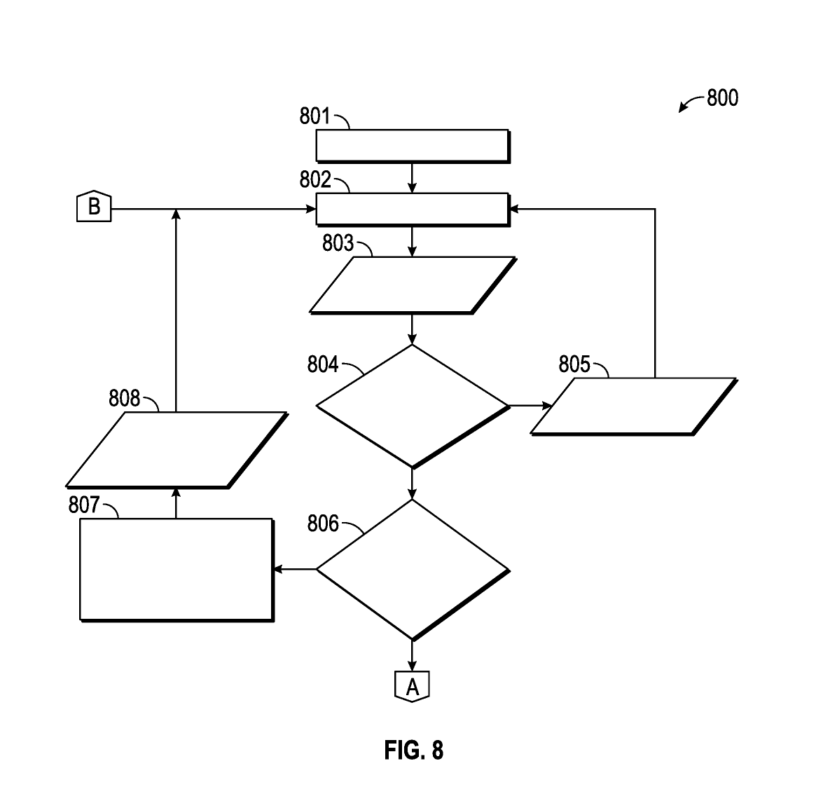

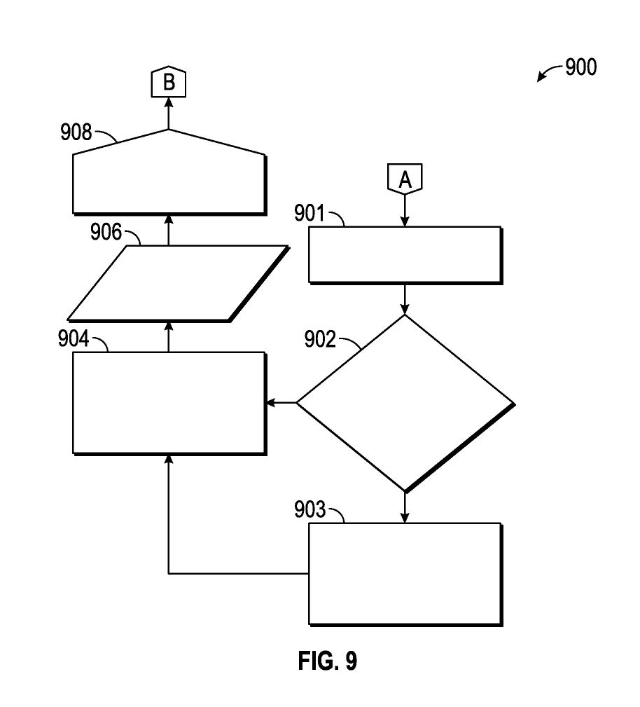

FIGS. 8 and 9 are flowcharts depicting, collectively, an exemplary driver assistance method in accordance with one embodiment, which will be described in conjunction with FIG. 1. First, in step 801, the system (e.g., module 102) is initiated. This might occur, for example, upon start-up of the vehicle. Module 108 then waits for sensor data (e.g., GPS and/or inertial data from sensors 121 and 122) (step 802), receives that data (step 803), and determines whether the vehicle is currently on a mapped road (e.g., a road that exists within database 106) (step 804). If the vehicle is not on a mapped road, the system outputs (to bus 105) an indicator that no path is available (e.g., a path id of zero), and returns to wait for sensor data (802).

If the vehicle is on a mapped road at step 804, the system determines, at step 806, whether the vehicle is on the same segment as the previous iteration of the process (which might occur at any particular sampling rate, such as 1-10 times per second). If the vehicle is on the same segment, the module 108 gets the current path ID and updates the distance from the origin (e.g., the starting point) of that segment (step 807). That path ID and vehicle position are then provided to device 104 via bus 105 (step 808), whereupon the system returns to wait for sensor data (802).

If, at step 806, it was determined that the vehicle is not on the same segment as the previous iteration, processing continues with step 901 (FIG. 9) and then determines (step 902) whether the current road segment is fully described in the path ID tables (e.g., FIG. 7), including available branches. That is, horizon provider module 108 may already know (and may have already sent to reconstructor module 112) sufficient path data regarding the current segment. If so, the process continues with step 904 and uses the existing path ID and updates the distance from the origin of the road segment. That path ID and vehicle position are then communicated to module 112 via bus 105 (step 906), wherein the system returns to step 802 and waits for further sensor data.

If, at step 902, the system determines that the road segment is not fully described, module 108 clears the prior-road path ID and assigns that path ID to a new sequence of segments, at the same time filling in any missing branches (step 903). Processing then continues as before with step 904.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A driver assistance method comprising:
determining, with a horizon provider module, a first path comprising a first road segment and a second road segment based on a position of a vehicle and a predetermined horizon distance;
determining a second path comprising the first road segment and a third road segment based on the position of the vehicle and the predetermined horizon distance;
transmitting, to a reconstructor module, path data characterizing the first path, the second path, a position of the vehicle relative to the first path, and a position of the vehicle relative to the second path.

2. The method of claim 1, wherein the path data characterizing the first and second path is transmitted over a car area network (CAN).

3. The method of claim 1, wherein the first road segment is selected from the group consisting of an intersection, a freeway entrance, a freeway entrance, and a roadway.

4. The method of claim, wherein the path data includes a sequence of road segments ordered based on driving direction and including an alphanumerical path record.

5. The method of claim 1, further including determining whether the first road segment is fully described and, if the road segment is not fully described, determining a new path corresponding to the first road segment.

6. A driver assistance system comprising:
a horizon provider module, including a processor;
a reconstructor module, including a processor, communicatively coupled to the horizon provider module via a data bus;
wherein the horizon provider module is configured to determine a first path comprising a first road segment and a second road segment based on a position of a vehicle and a predetermined horizon distance; determine a second path comprising the first road segment and a third road segment based on the position of the vehicle and the predetermined horizon distance; and simultaneously transmit, to the reconstructor module, path data characterizing the first path, the second path, a position of the vehicle relative to the first path, and a position of the vehicle relative to the second path.

7. The system of claim 6, wherein the path data characterizing the first and second path is transmitted over a car area network (CAN).

8. The system of claim 6, wherein the first road segment is selected from the group consisting of an intersection, a freeway entrance, a freeway entrance, and a roadway.

9. The system of claim 6, wherein the path data includes a sequence of road segments ordered based on driving direction and including an alphanumerical path record.

10. The system of claim 6, wherein the horizon provider module further determines whether the first road segment is fully described and, if the road segment is not fully described, determines a new path corresponding to the first road segment.

11. A horizon provider module including a processor and software instructions configured to cause the processor to perform the steps of:
determining a first path comprising a first road segment and a second road segment based on a position of a vehicle and a predetermined horizon distance;
determining a second path comprising the first road segment and a third road segment based on the position of the vehicle and the predetermined horizon distance; and
simultaneously transmitting, to a reconstructor module communicatively coupled to the horizon provider module via a bus, path data characterizing the first path, the second path, a position of a vehicle relative to the first path, and a position of the vehicle relative to the second path.

12. The horizon provider module of claim 11, wherein the path data characterizing the first and second path is transmitted over a car area network (CAN).

13. The horizon provider module of claim 11, wherein the first road segment is selected from the group consisting of an intersection, a freeway entrance, a freeway entrance, and a roadway.

14. The horizon provider module of claim 11, wherein the path data includes a sequence of road segments ordered based on driving direction and including an alphanumerical path record.

15. The horizon provider module of claim 11, wherein the horizon provider module further determines whether the first road segment is fully described and, if the road segment is not fully described, determines a new path corresponding to the first road segment.
